(19) United States
(12) Patent Application Publication
(10) Pub. No.: US 2010/0018418 A1
(43) Pub. Date: Jan. 28, 2010

(54) Printing Unit In A Roll-Fed Printing Press

(75) Inventors: Peter KNAUER, Munster/Lech (DE); Josef SINGLER, Binswangen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Manroland AG, Offenbach am Main (DE)

(21) Appl. No.: 12/506,769

(22) Filed: Jul. 21, 2009

(30) Foreign Application Priority Data
Jul. 22, 2008 (DE) 10 2008 034 286.6

(51) Int. Cl. B41F 13/54

(52) U.S. Cl. 101/228

(57) ABSTRACT

A printing unit for a roll-fed printing press having at least two printing mechanisms, wherein a first printing mechanism imprints a first side of a web-shaped substrate and a second printing mechanism imprints a second side of the web-shaped substrate opposite to the first side. The first printing mechanism and second printing mechanism each have a form cylinder, a transfer cylinder, an inking unit, and preferably a dampening unit. The transfer cylinders of the first printing mechanism and the second printing mechanism roll on one another while forming a printing gap for the substrate to be imprinted. A main driving motor is associated with the first printing mechanism or the second printing mechanism. A braking motor is associated with the printing mechanism with which the main driving motor is not associated.

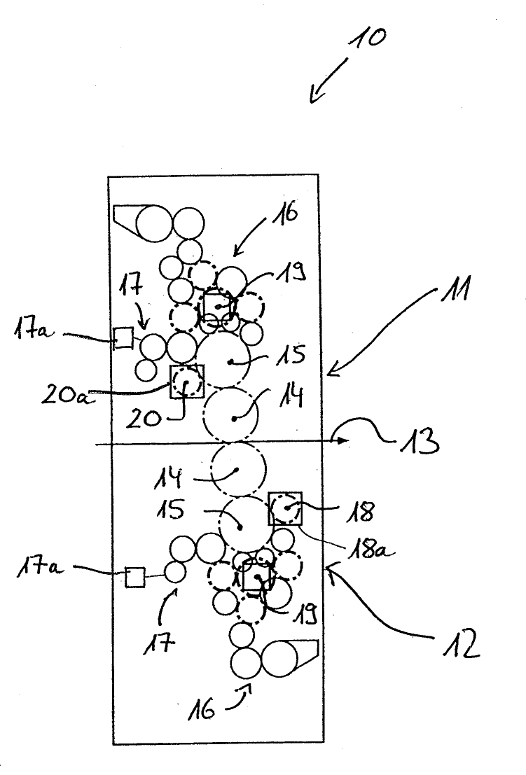

### BACKGROUND OF THE INVENTION

1. Field of the Invention

The present invention is directed to a printing unit and, more particularly, to a printing unit in a roll-fed printing press having at least two printing mechanisms in which a first printing mechanism imprints a first side of a web-shaped substrate and a second printing mechanism imprints a second side of the web-shaped substrate opposite to the first side.

2. Description of the Related Art

Printing units in roll-fed printing presses have a plurality of printing mechanisms, where each printing mechanism has a transfer cylinder, a form cylinder that rolls on the transfer cylinder, an inking unit, and preferably a dampening unit. At least one printing form is positioned on the form cylinder of each printing mechanism. In addition, at least one transfer form is positioned on the transfer cylinder of every printing mechanism. Form cylinders are also referred to as plate cylinders, transfer cylinders, and rubber cylinders.

The printing mechanisms of a printing unit in a roll-fed printing press serve to imprint both sides of a web-shaped substrate. The substrate is transported through a printing gap, as it is called, for printing. Typically, a printing gap is formed by two transfer cylinders of two printing mechanisms, with these transfer cylinders rolling on one another and serving to imprint the substrate on opposite sides thereof.

It is known to use main driving motors to drive the cylinders, i.e., the form cylinders and transfer cylinders, of two printing mechanisms that cooperate with one another and whose transfer cylinders roll on one another and form the printing gap for imprinting both sides of a web-shaped substrate. In conventional printing units, the main driving motors also drive the inking units of the printing mechanisms.

As a result of the mechanical coupling between the cylinders, i.e., the form cylinders and transfer cylinders, of the printing mechanisms and the inking units thereof, technical printing problems can arise. Such problems arise particularly when the cylinders have a large axial width and a small circumference, i.e., when the cylinders are relatively slender.

### SUMMARY OF THE INVENTION

It is therefore an object of the invention to provide printing unit for a roll-fed printing press by which a higher print quality can be provided. This and other objects and advantages are achieved in accordance with the invention by a printing unit of a roll-fed printing press having a plurality of printing mechanisms. A first printing mechanism of the plurality of mechanisms imprints a first side of a web-shaped substrate. A second printing mechanism of the plurality of mechanisms imprints a second side of the web-shaped substrate opposite to the first side of the web-shaped substrate. The first and second printing mechanisms each have a form cylinder, a transfer cylinder, an inking unit, and preferably a dampening unit. The transfer cylinders of the first and second printing mechanisms roll on one another while forming a printing gap for the web-shaped substrate to be imprinted.

In accordance with the invention, a main driving motor, which drives the form cylinders and the transfer cylinders of the first printing mechanism and of the second printing mechanism in the production run, is associated with the first printing mechanism or the second printing mechanism. A braking motor is associated with the printing mechanism with which the main driving motor is not associated, where the braking motor provides a defined gear face position or tooth edge position for the form cylinders and the transfer cylinders of the first printing and second printing mechanisms in the production run.

In accordance with the invention, a braking torque is introduced in the cylinders of the two printing mechanisms by the braking motor to ensure a defined tooth edge position for the form cylinders and transfer cylinders. Consequently, it becomes possible to prevent print-related problems and to provide a high print quality.

A direct drive motor is preferably associated with each inking unit of the first printing and second mechanisms, where the direct drive motor drives the respective inking unit in the production run as a dedicated motor. As a result, the mechanical coupling between the cylinders of the printing mechanisms and the inking units thereof is canceled.

Other objectives and advantages of the invention will become apparent from the following detailed description considered in conjunction with the accompanying drawings and diagrams. The principles and features of the invention may be used in various different embodiments without departing from the scope of the invention.

### BRIEF DESCRIPTION OF THE DRAWINGS

The various features, functions and advantages characterizing the invention will be better understood by reference to the detailed description which follows, taken in conjunction with the accompanying drawing, in which:

The drawing shows a schematic view of a printing unit for a roll-fed printing press in accordance with the invention.

### DETAILED DESCRIPTION OF THE EXEMPLARY EMBODIMENTS

The invention is directed to a printing unit of a roll-fed printing press. A printing unit of this kind comprises a plurality of printing mechanisms for imprinting both sides of a web-shaped substrate. The sole drawing shows a schematic view of a printing unit 10 of an illustrative printing press having two printing mechanisms 11, 12 for imprinting both sides of a web-shaped substrate 13 which is transported through the printing mechanism 10 in the horizontal direction. Each of the two printing mechanisms 11 and 12, which cooperate with one another, has a transfer cylinder 14, a form cylinder 15, an inking unit 16, and a dampening unit 17. Printing ink is applied to the printing form positioned on the respective form cylinder 15 by the inking unit 16, and dampening solution is applied to the printing form positioned on the respective form cylinder 15 by the dampening unit 17. The printing ink is applied to the substrate 13 by transfer forms positioned on the transfer cylinder 14, starting from the form cylinder 15 by way of the transfer cylinders 14. The two transfer cylinders 14 of the printing mechanisms 11, 12 roll on one another while forming a printing gap for the substrate 13. Accordingly, the transfer cylinder 14 of the printing mechanism 12 forms an impression cylinder for the transfer cylinder 14 of the printing mechanism 11. The transfer cylinder 14 of the printing mechanism 11 forms an impression cylinder for the transfer cylinder 14 of printing mechanism 12.

As previously explained, the two printing mechanisms 11, 12 whose transfer cylinders 14 roll on one another while forming the printing gap for the substrate 13 serve for imprinting both sides of the substrate 13. In the contemplated exemplary embodiment, the first printing mechanism 11 imprints the substrate 13 on an upper side, and the second printing mechanism 12 imprints the substrate 13 on an underside.

Within the meaning of the contemplated embodiments, a main driving motor 18, which drives the form cylinders 15 and the transfer cylinders 14 of the two printing mechanisms 11, 12 in the production run, is associated with one of the two printing mechanisms 11, 12. In the present exemplary embodiment, the main driving motor 18 is associated with the form cylinder 15 of the second printing mechanism 12, and the main driving motor 18 drives the form cylinder 15 of the second printing mechanism 12 directly, and drives the transfer cylinders 14 of the two printing mechanisms 11, 12 and the form cylinder 15 of the first printing mechanism 11 indirectly by a spur gear or toothed gear connection 18a. The main driving motor 18 can also drive into the form cylinder 15 of the printing mechanism 12 indirectly with the intermediary of an intermediate wheel (not shown).

In the preferred embodiment, a direct drive motor 19 is associated, respectively, with the two inking units 16 of the printing mechanisms 11, 12 and drives the respective inking unit 16 in the production run as a dedicated motor, i.e., without mechanical coupling with the cylinders 14, 15 of the first and second printing mechanisms 11, 12. Accordingly, the direct drive motor 19 is associated in each instance with the inking units 16 of the first printing mechanism 11 and the second printing mechanism 12 such that no mechanical driving connection is provided between the inking units 16 and the cylinders 14, 15 of the printing mechanisms 11, 12 in the production run. However, the inking units can also be driven proceeding from the main driving motor.

A braking motor 20 is associated with the printing mechanism with which the main driving motor 18 is not associated, i.e., in the contemplated exemplary embodiment, the first printing mechanism 11. This braking motor 20 provides a defined tooth edge 20a position for the form cylinders 15 and the transfer cylinders 14 of the two printing mechanisms 11, 12 in the production run.

Accordingly, the braking motor 20 has only a braking function, but is not tasked with providing a driving function. As further shown in the drawing, the braking motor 20 is associated with the form cylinder 15 of the first printing mechanism 11. The main driving motor 18, however, is not associated with the first printing mechanism 11. The braking motor 20 introduces a braking torque in the form cylinder 15 of the first printing mechanism 11 directly, and introduces a braking force into the other cylinders 14, 15 indirectly by the spur gear or toothed gear connections 18a. The braking motor 20 can also drive the form cylinder 15 of the first printing mechanism 11 indirectly with the intermediary of an intermediate wheel (not shown).

As a result, it becomes possible to lock the form cylinders 15 and transfer cylinders 14 of both printing mechanisms 11, 12 together so as to provide a defined tooth edge 20a position for the form cylinders 15 and transfer cylinders 14 of both printing mechanisms 11, 12 in the production run.

Accordingly, the printing unit 10 which is shown in the drawing and which comprises the two printing mechanisms 11, 12 has a total of at least four motors. A main driving motor 18 is associated with one of the two printing mechanisms, and a driving torque is driven in or introduced into the form cylinders 15 and transfer cylinders 14 of the two printing mechanisms 11, 12 by the main driving motor 18. The main driving motor 18 is associated with the form cylinder 15 of a printing mechanism so that the main driving motor 18 drives this form cylinder 15 directly, and drives the other cylinders of the two printing mechanisms 11,12 indirectly via toothed gear connections 18a. A direct drive is associated with each of the inking units 16 of the two printing mechanisms 11, 12 to drive the inking units 16 as a dedicated motor in the production run without a mechanical coupling with the cylinders 14, 15. This prevents torque shocks in the inking units 16 from being transmitted to the cylinders 14, 15 of the printing mechanisms 11. A braking drive 20 is associated with the printing mechanism with which the main driving motor 18 is not associated. This braking drive 20 is associated with the form cylinder of the corresponding printing mechanism and introduces a braking torque into the form cylinders 15 and transfer cylinders 14 of the two printing mechanisms 11,12.

Consequently, the form cylinders 15 and transfer cylinders 14 of the two printing mechanisms 11, 12 are locked together to provide or maintain a defined tooth edge 20a position in the drivetrain of the transfer cylinders 14 and form cylinders 15. As previously explained, it is also possible—in contrast to the preferred embodiment shown in the drawing—for the inking units to not have direct drives such that they are instead driven proceeding from the main driving motor.

Direct drive motors 17a are preferably associated with the dampening units 17 of the two printing mechanisms 11, 12 and drive the respective dampening unit 17 as a dedicated motor in the production run. Printing mechanisms 11, 12 with directly driven dampening units 17 are applied particularly in illustration printing presses with a horizontal web run of the substrate 13. It is also possible to drive the dampening units proceeding from the main driving motor by spur gear connections 18a, i.e., in newspaper printing presses having a web-substrate that runs in the vertical direction.

The form cylinders 15 of the first and second printing mechanisms are preferably slender with a large axial width and a small circumference. For example, the form cylinders 15 can be constructed as 4/1 form cylinders, 6/2 form cylinders or 6/1 form cylinders, where the first number indicates the quantity of printable sides next to one another in the axial direction, and the second number indicates the quantity of printable sides one behind the other in the circumferential direction per revolution of the form cylinder.

As schematically depicted in the drawing, the transfer cylinders 14 have the same circumference and, thus, the same axial width as the form cylinders 15. The circumference of the transfer cylinders 14 can also be an integral multiple of the circumference of the form cylinders 15.

Thus, while there are shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. Printing unit for a roll-fed printing press having a plurality of printing mechanisms, comprising:
a first printing mechanism of said plural mechanisms which imprints a first side of a web-shaped substrate;
a second printing mechanism of said plural mechanisms which imprints a second side of the web-shaped substrate opposite to the first side of the web-shaped substrate, the first printing mechanism and second printing mechanism each having a form cylinder, a transfer cylinder, an inking unit and a dampening unit, and the transfer cylinder of the first printing mechanism and the transfer cylinder of the second printing mechanism roll on one another while forming a printing gap for the web-shaped substrate to be imprinted;
a main driving motor which drives the form cylinders, the transfer cylinder of the first printing mechanism and the transfer cylinder of the second printing mechanism in a production run being associated with one of the first printing mechanism and the second printing mechanism; and
a braking motor associated with the other of the first printing mechanism and the second mechanism with which the main driving motor is not associated, the braking motor providing a defined tooth edge position for the form cylinder and the transfer cylinder of the first printing mechanism and the form cylinder and the transfer cylinder of the second printing mechanism in the production run.

2. The printing unit according to claim 1, further comprising:
a direct drive motor associated with each inking unit of the first printing mechanism and the second printing mechanism;
wherein the direct drive motor drives a respective inking unit in the production run as a dedicated motor.

3. The printing unit according to claim 1, wherein the main driving motor associated with one of the first printing mechanism and the second printing mechanism directly or indirectly drives the form cylinder of the one of the first printing mechanism and the second printing mechanism and indirectly drives other transfer and form cylinders of the first and second printing mechanisms by spur gear connections.

4. The printing unit according to claim 2, wherein the main driving motor associated with one of the first printing mechanism and the second printing mechanism directly or indirectly drives the form cylinder of the one of the first printing mechanism and the second printing mechanism and indirectly drives other transfer and form cylinders of the first and second printing mechanisms by spur gear connections.

5. The printing unit according to claim 2, wherein the direct drive motor drives a respective inking unit of the first printing mechanism and the second printing mechanism without any mechanical coupling with the transfer and form cylinders of the first and second printing mechanisms.

6. The printing unit according to claim 3, wherein the direct drive motor drives a respective inking unit of the first printing mechanism and the second printing mechanism without any mechanical coupling with the transfer and form cylinders of the first and second printing mechanisms.

7. The printing unit according to claim 1, wherein the braking motor associated with the other of the first printing mechanism and the second printing mechanism directly or indirectly introduces a braking torque into the form cylinder of the other of the first printing mechanism and the second printing mechanism in the production run and indirectly introduces a braking moment into other cylinders of said plural printing mechanisms via spur gear connections in the production run to lock the cylinders of said plural printing mechanisms with respect to one another.

8. The printing unit according to claim 1, wherein direct drive motors are associated with dampening units of the first printing mechanism and the second printing mechanisms, said direct drive motors driving a respective dampening unit as a dedicated motor in the production run.

9. The printing unit according to claim 6, wherein the printing unit is constructed as a printing mechanism of an illustration printing press having a horizontal web run of the web-shaped substrate.

10. The printing unit according to claim 1, wherein each dampening unit is driven proceeding from the main driving motor by spur gear connections.

11. The printing unit according to claim 8, wherein the printing unit is constructed as a printing mechanism of a newspaper printing press having a vertical web run of the web-shaped substrate.
